(19) United States
(12) Patent Application Publication
(10) Pub. No.: US 2006/0165375 A1
(43) Pub. Date: Jul. 27, 2006

(54) Recordable PVR using metadata and recording control method thereof

(75) Inventors: Jeong-Seok Choi, Seoul (KR); Jeong-Rok Park, Hwaseong-si (KR); Kwan-Lae Kim, Suwon-si (KR); Yun-Je Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/286,647

(22) Filed: Nov. 25, 2005

(30) Foreign Application Priority Data
Nov. 26, 2004 (KR) 2004-98179

(51) Int. Cl. H04N 5/91; H04B 1/66

(52) U.S. Cl. 386/83; 375/240

(57) ABSTRACT

Disclosed are a personal video recorder (PVR) using metadata and a recording control method thereof that facilitates the selective recording of user-preferred segments of a broadcast program in real time. The PVR includes a broadcast receiver for receiving the digital broadcast and dividing the digital broadcast program into video data, audio data, and metadata. The PVR also includes a DS analyzer for analyzing the metadata and outputting program-related information corresponding to the digital broadcast program, a user input unit for receiving recording preference information from a user for recording the digital broadcast program, a program information processor for filtering the program-related information using the user-supplied recording preference information, a synchronous buffer for temporarily storing the video data and the audio data, a recording unit for encoding and storing the video data and the audio data temporarily stored in the synchronous buffer, and a control unit for comparing the filtered program information with the recording preference information and controlling the synchronous buffer and the recording unit in accordance with the results of a comparison.

### CLAIM OF PRIORITY

This application claims priority to an application entitled “Recordable PVR Using Metadata and Recording Method Thereof,” filed in the Korean Intellectual Property Office on Nov. 26, 2004 and assigned Serial No. 2004-98179, the contents of which are hereby incorporated by reference.

### BACKGROUND OF THE INVENTION

1. Field of the Invention

The present invention relates generally to digital broadcasting and recording, and more particularly to an apparatus and method for selectively recording user-preferred segments of a transmitted digital broadcast program in real-time by analyzing metadata transmitted along with a digital broadcast program in a single transport stream.

2. Description of the Related Art

Presently, digital broadcasting services are provided through broadcasting systems constructed according to two international standards, ISO/IEC 13818-1 and ISO/IEC 13818-2. ISO stands for the International Standards Organization and IEC stands for the International Electrotechnical Commission. International standards document ISO/IEC 13818-2, defines the international standard on motion picture compression and is described for video in the MPEG-2 standard which relates to video data. International standards document ISO/IEC 13818-1 is the international standard on multiplexing compressed image data, audio data, and other data in a broadcast transmitter and demultiplexing the multiplexed compressed image data, audio data, and other data in a broadcast receiver. The term “other data” refers to information including program-related information.

FIG. 1 is a block diagram of a conventional digital broadcasting system according to the prior art. The digital broadcasting system includes a transmitter 11 and a receiver 12. The transmitter 11 includes an MPEG-2 video encoder 111 for receiving video data (“VIDEO”) of a digital broadcast program to be transmitted and for encoding the video data into an MPEG-2 video stream. The transmitter 11 also includes an MPEG/AC-3 audio encoder 112 for receiving audio data (“AUDIO”) of the digital broadcast program to be transmitted and for encoding the audio data into an MPEG/AC-3 audio stream. The transmitter 11 also includes a multiplexer 113 for receiving and multiplexing the MPEG-2 video stream output from the MPEG-2 video encoder 111, the MPEG/AC-3 audio stream output from the MPEG/AC-3 audio encoder 112, and program-related information of the digital broadcast program. The digital broadcast program is transmitted as a single multiplexed transport stream.

The receiver 12 includes a demultiplexer 121 for receiving the digital broadcast program transmitted from transmitter 11 through a digital channel as a single multiplexed transport stream. The demultiplexer 121 outputs a compressed MPEG-2 videostream, a compressed MPEG/AC-3 audiostream, and program-related information (“OTHER DATA”). The compressed MPEG-2 video stream output from demultiplexer 121 is provided as input to an MPEG-2 video decoder 122 shown in FIG. 1 for decoding the compressed MPEG-2 video stream. The compressed MPEG/AC-3 audio signal output from demultiplexer 121 is provided as input to the MPEG/AC-3 audio decoder 123 for decoding the compressed MPEG/AC-3 audio stream.

FIG. 2 is a block diagram illustrating an exemplary broadcast recording unit in a conventional personal video recorder (PVR).

The PVR of FIG. 2 corresponds to the receiver 12 of the digital broadcast system of FIG. 1, described above, and is identical in its basic construction. However, the PVR of FIG. 2 is distinguishable from the receiver 12 of FIG. 1 in that it includes a number of additional modules including a program information processor 21 for receiving and processing program-related information (“Other Data”). The PVR also includes a user input unit 22 for receiving one or more control commands from a user, an MPEG-2 encoder 23 for encoding an MPEG-2 video stream and an MPEG/AC-3 audio stream. Both streams are output from the demultiplexer 121 prior to being decoded by the MPEG-2 Video Decoder 122 and MPEG/AC-3 Audio Decoder 123, respectively. The PVR also includes a storage unit 24 for storing the data encoded by the MPEG-2 encoder 23, and a control unit 25 for receiving a first input comprising program information from the program information processor 21 and a second input comprising a user control command from the user input unit 22. The control Unit 25 also controls the MPEG-2 encoder 23 to encode and store the transmitted broadcast program.

The digital broadcast program is recorded by the recordable PVR of FIG. 2 in the following manner. A user selects a desired recording preference of the broadcast program received at the PVR by inputting a user control command via user input unit 22. It is noted that while the recording preference can be determined by the user via the user control command, this ability is limited in those situations where the program-related information transferred from the transmitter 11 is restricted. That is, as is well known, a recording is generally performed by setting a start point and an end point to store a broadcast program or by storing the broadcast program in accordance with program information and EPG information transmitted with the broadcast program. However, neither method permits the recording of desired portions or segments of a broadcast program.

While it is conceivable to transmit the broadcast program together with program-related information, such as, for example, MPEG-7 or MPEG-21 encoded metadata, to allow only desired portions or segments of a broadcast program to be recorded, a drawback associated with conventional PVRs is that they are not presently configured to utilize the transmitted metadata to accommodate the recording of desired portions or segments of a broadcast program.

It would therefore be desirable to have a recording system and apparatus that accommodates recording of desired portions or segments of a broadcast program in real-time using the afore-mentioned metadata.

### SUMMARY OF THE INVENTION

Accordingly, the present invention solves the above and other problems in the prior art, by providing a recordable PVR and a recording control method that records user preferred segments of a broadcast program in real time by comparing user provided data with that of metadata transmitted along with the broadcast program in real-time.

According to one aspect, there is provided a personal video recorder (PVR) for recording a digital broadcast, comprising a broadcast receiver for receiving a digital broadcast program and separating the digital broadcast program into video data, audio data and metadata, a description schemes (DS) analyzer for analyzing the metadata transmitted along with the broadcast program in real-time and outputting program-related information, a user input unit for receiving recording preference information from a user, a program information processor for receiving the digital broadcast program-related information output from the DS analyzer and filtering the digital broadcast program-related information in accordance with recording preference information provided by the user, a synchronous buffer for temporarily storing the video data and the audio data while processing the program-related information of the digital broadcasting program to allow the video data and the audio data to be stored in real time, a recording unit for receiving and encoding the video data and the audio data temporarily stored in the synchronous buffer, and a control unit for comparing the program information filtered by the program information processor with the recording preference information input by the user input unit and controlling the synchronous buffer and the recording unit to store the video data and the audio data in accordance with the comparison results.

In accordance with another aspect of the present invention, there is provided a method of controlling a PVR for recording preferred segments of a digital broadcast, the method comprising a first step of receiving recording preference information from a user, a second step of receiving real-time program-related information from the received digital broadcast program, a third step of determining whether the recording preference information provided by the user matches the real-time program-related information, derived from meta-data transmitted along with digital broadcast program, and, in the case of a match, initiating the recording of the digital broadcast program, and a fourth step of stopping the recording of the digital broadcast program when the user provided recording preference information does not match the real-time program-related information

### BRIEF DESCRIPTION OF THE DRAWINGS

FIG. 1 is a block diagram illustrating a conventional digital broadcasting system according to the prior art;

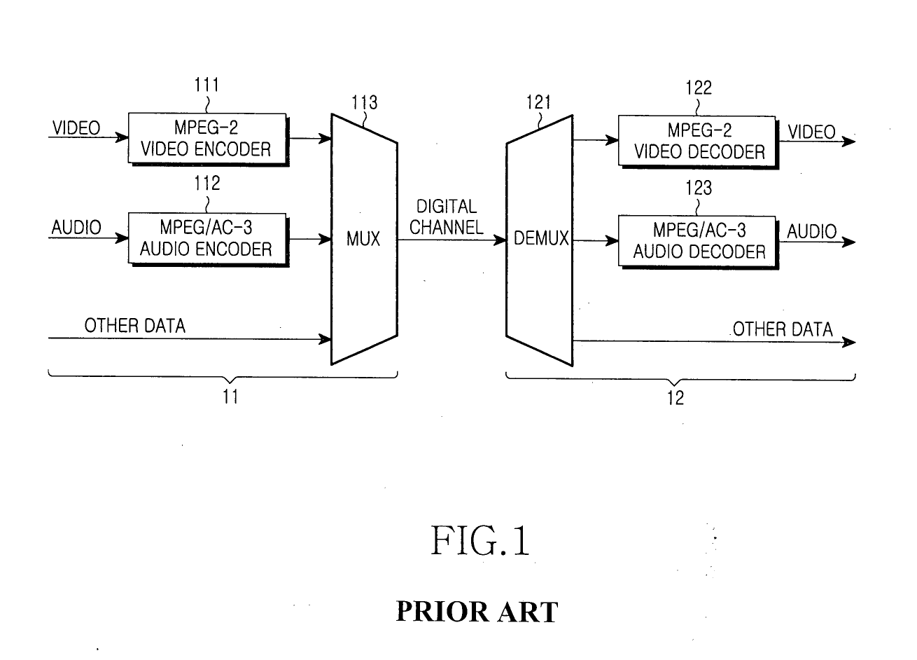

FIG. 2 is a block diagram illustrating a conventional broadcasting recording unit in a PVR, according to the prior art;

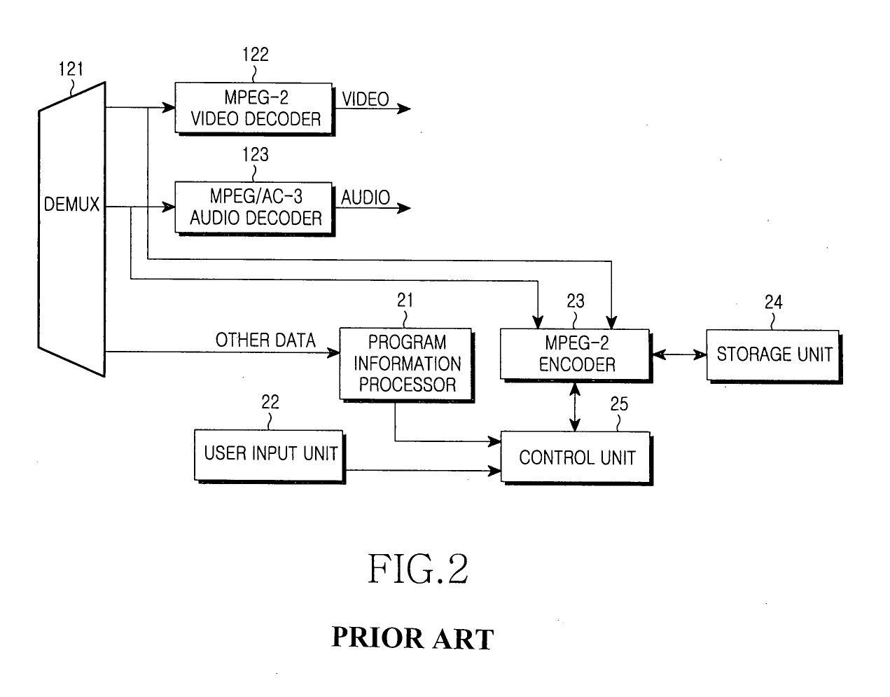

FIG. 3 is a block diagram illustrating a digital broadcasting system according to an embodiment of the present invention;

FIG. 4 is a block diagram illustrating a recordable PVR using metadata according to an embodiment of the present invention; and

FIG. 5 is a flowchart illustrating the operation of a control unit of a recordable PVR of FIG. 4 using meta data according to an embodiment of the present invention.

### DETAILED DESCRIPTION

Now, embodiments of the present invention will be described in detail hereinafter with reference to the accompanying drawings. Although a number of specific features, such as detailed constituent elements, are given in the following description of the present invention, they are presented only to provide a better understanding of the present invention. Also, it will be clear to those skilled in the art that such specific features can easily be changed or modified within the scope of the present invention.

As broadcasting techniques increasingly shift from the analog to the digital domain, diverse services which heretofore could not have been provided by analog broadcasts are now being provided by digital broadcast techniques. Such diverse services include, for example, interactive broadcasting and high-definition broadcasting.

In an embodiment of the present invention, a method is provided for utilizing program-related information regarding digital broadcast programs transmitted from a transmitter using the “Multimedia Description Schemes” defined in the MPEG-7 Standard, Part 5. MPEG-7 is the MPEG standard corresponding to ISO/IEC 15938-5, the international standard for digital broadcasting and the standard and multimedia data in particular. This program-related information provides the user with a capability to selectively record only desired segments of a digital broadcast program.

A method of controlling a PVR for selectively recording a digital broadcast is now explained by way of example in the context of a digital broadcast of a baseball game. A user wishes not to view or record the baseball game in its entirety, but instead desires to only record certain scenes or segments of the broadcast pertaining to those players of interest to the user. Once recorded, the user preferably stores the desired scenes as data files for viewing at a later time.

To record only those scenes involving a player of interest to the user, the user inputs the name of an interested player (or players), which is stored as recording preference information in the PVR. The PVR is set to record mode. In the record mode, the PVR is capable of determining which player is presently playing the baseball game based on program-related information derived from metadata included in a specified field of the broadcast program transport stream, and starts recording the broadcast program whenever the broadcast program includes program-related information that stores the recording preference information (i.e., the player of interest specified by the user). Correspondingly, the PVR stops recording whenever the program-related information does not include information matching the player of interest, supplied by the user as recording preference information.

In the present illustrative embodiment, MPEG-7 encoding is used to transmit the program-related information, however, in alternate embodiments other encoding schemes may be used which are well known in the art, such as, for example, MPEG-21 encoding.

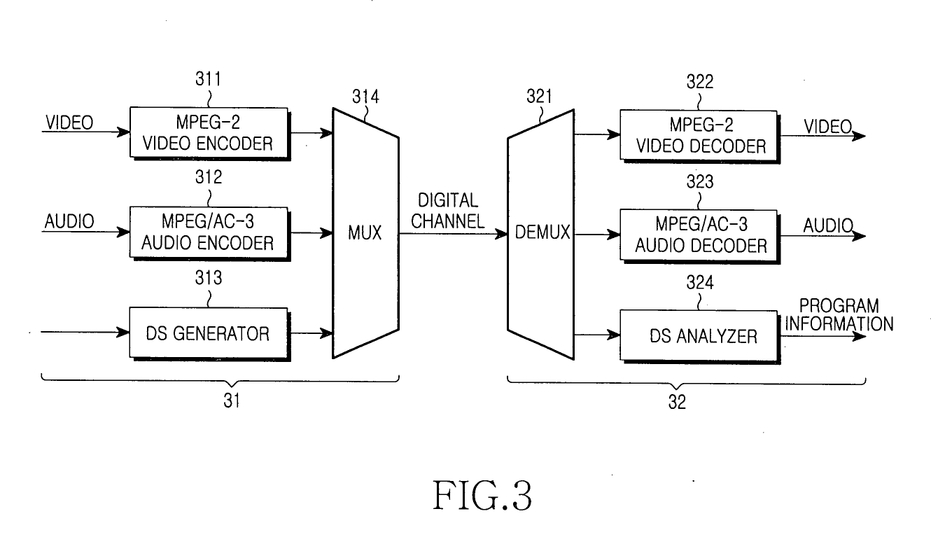

FIG. 3 is a block diagram illustrating a digital broadcasting system according to an embodiment of the present invention. As shown in FIG. 3, the digital broadcasting system includes a transmitter 31 and a receiver 32. The transmitter 31 includes an MPEG-2 video encoder 311 for receiving and encoding video data (“VIDEO”) of a digital broadcast program transmitted as an MPEG-2 video stream, an MPEG-AC-3 audio encoder 312 for receiving and encoding audio data (“AUDIO”) of the digital broadcast program transmitted as an MPEG/AC-3 audio stream, a description schemes (DS) generator 313 for receiving and encoding program-related information related to the digital broadcast program to be transmitted as MPEG-7 encoded metadata, and a multiplexer 314 for multiplexing outputs of the MPEG-2 video encoder 311, MPEG/AC-3 audio encoder 312 and DS generator 313, to transmit the digital broadcast program as a single transport stream.

The receiver 32 of FIG. 3 includes a demultiplexer 321 for receiving the digital broadcast program transmitted from the transmitter 31 through a digital channel and for separating the transmitted digital broadcast program into an MPEG-2 video signal, an MPEG/AC-3 audio signal, and other signals. The receiver 32 also includes an MPEG-2 video decoder 322 for decoding the MPEG-2 video stream output from the demultiplexer 321, and an MPEG/AC-3 audio decoder 323 for decoding the MPEG/AC-3 audio stream output from the demultiplexer 321. The receiver 32 also includes a description schemes (DS) analyzer 324 for decoding MPEG-7 encoded data output from the demultiplexer 321 to obtain the program-related information of the digital broadcast program.

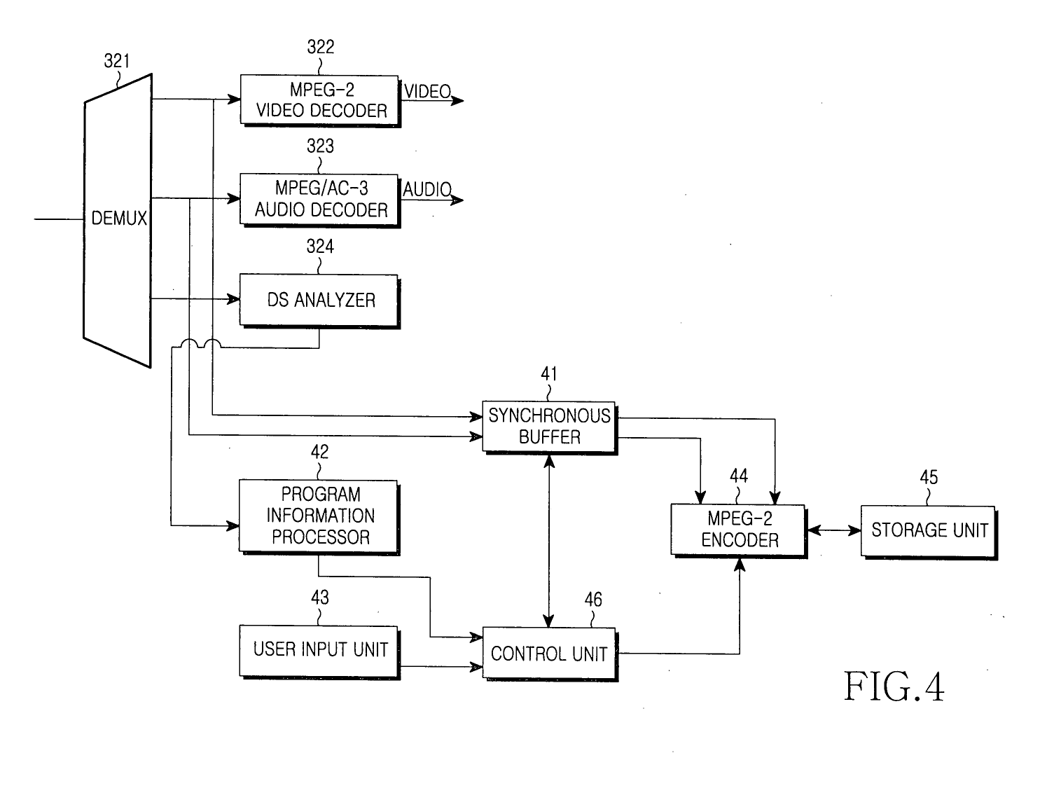

The PVR of FIG. 4 corresponds to the receiver 32 of the digital broadcast system described above and is identical in its basic construction. However, the PVR is distinguishable from the digital broadcasting system of FIG. 3 in that it further includes a program information processor 42 for receiving the program-related information of the digital broadcast program output from the DS analyzer 324 and for filtering the program-related information in accordance with user provided recording preference information from the user input unit 43.

The PVR of FIG. 4 also includes a synchronous buffer 41 for temporarily storing the MPEG-2 video stream and the MPEG/AC-3 audio stream output from the demultiplexer 321 for a desired period in order to encode and store the two streams in real time before the streams are decoded by MPEG-2 Video Decoder 322 and MPEG/AC-3 Audio Decoder 323, respectively. The MPEG-2 encoder 44 of FIG. 4 receives the MPEG-2 video stream and the MPEG/AC-3 audio stream which are temporarily stored in the synchronous buffer 41 and encodes the respective streams for storage in storage unit 45.

The PVR also includes a control unit 46 for receiving the program-related information output from the program information processor 42 as a first input and a control command including the recording preference information for the user's recording from the user input unit 43 as a second input. The control unit 46 uses the provided inputs to manage operations associated with encoding and storing the input broadcast program by controlling the synchronous buffer 41 and the MPEG-2 encoder 44.

In operation, a digital broadcast program, transmitted as a single transport stream over a digital channel, is recorded using the PVR of FIG. 4 as follows. A user inputs recording preference information via the user input unit 43. The control unit 46 records segments of the broadcast program in real time by comparing the user provided recording information with program-related information, received as a part of the digital broadcast program. If the program-related information matches the user provided recording preference information, a recording of the broadcast program is initiated at that point in time. At a later point in time when it is determined that there is no longer a match, the recording is stopped. This process of starting and stopping recording may occur multiple times throughout a broadcast.

It should be noted that a conventional PVR does not provide a capability of recording segments of a real-time digital broadcasting in the manner described above.

Because a digital broadcast is transmitted and received in real time, a user may miss the opportunity to record a particular program being broadcast while confirming the program information. To prevent this problem, the present invention employs a synchronous buffer 41. The synchronous buffer 41 temporarily stores the MPEG-2 video stream and the MPEG/AC-3 audio stream output from the demultiplexer 321 for a desired period so that the user does not miss the broadcast program even while the program information is being processed and stored. In one embodiment, the synchronous buffer 41 is a FIFO-type buffer which temporarily stores data for a desired period (e.g. on the order of 1 second) and continuously transmits time information of the stored data to the control unit 46. The control unit 46 can control the recording according to the information on the data to be stored, which is obtained from the program information, the recording preference information, and the time information of the data stored in the synchronous buffer 41.

The storage unit 45 is typically embodied as a hard disk, but may be embodied as other diverse storage media in other embodiments.

The MPEG-7 encoded data comprising the program-related information transmitted as part of the digital transport stream is now described in detail with reference to FIGS. 3 and 4. The DS generator 313 of FIG. 3 receives program-related information related to images of the broadcast program and generates “description schemes” in a format described in “ISO/IEC15938-5 Part 5: Multimedia Description Schemes” as shown, by way of example, in Table I below. Table I provides a definition of a “Person” description scheme (DS).

```
TABLE 1
    <!--  #####################################################
-->
    <!-- Definition of Person DS  --
>
    <!--  #####################################################
-->
    <complexType name=“PersonType”>
      <complexContent>
      <extension base=“mpeg7:AgentType”>
        <sequence minOccurs=“1” maxOccurs=“1”>
        <element name=“Name” type=“mpeg7:PersonNameType”
                            minOccurs=“1” maxOccurs=“unbounded”/>
        <element  name=“Affiliation” minOccurs=“0”
maxOccurs=“unbounded”>
      <complexType>
      <choice minOccurs=“1” maxOccurs=“1”>
        <element name=“Organization” type=“mpeg7:OrganizationType”
          minOccurs=“1” maxOccurs=“1”/>
        <element name=“OrganizationRef” type=“mpeg7:ReferenceType”
          minOccurs=“1” maxOccurs=“1”/>
        <element name=“PersonGroup” type=“mpeg7:PersonGroupType”
          minOccurs=“1” maxOccurs=“1”/>
        <element name=“PersonGroupRef” type=“mpeg7:ReferenceType”
          minOccurs=“1” maxOccurs=“1”/>
        </choice>
      </complexType>
      </element>
        <element  name=“ElectronicAddress”
type=“mpeg7:ElectronicAddressType”
          minOccurs=“0” maxOccurs=“unbounded”/>
        </sequence>
      </extension>
      </complexContent>
</complexType>
```

The definition of various content that is described in the ISO/IEC15938-5 standard is described in Table 2.

TABLE 2

| Name | Definition |
|---|---|
| PersonType | DS describing an individual person |
| Name | Describes the names associated with this person. |
| | Multiple names are allowed. The interpretation of |
| | different name is not [symbol] |
| Affiliation | Describes an organizations or person groups with |
| | which this person is affiliated. For example, the |
| | company for which the individual works the sports |
| | team on which they place and so [symbol] |
| Organization | Describes an organization that this person is |
| | affiliated with. |
| OrganizationRef | References an organization that this person |
| | is affiliated with. |
| PersonGroup | Describes a group that this person is affiliated |
| | with. |
| PersonGroupRef | References a person group that this person is |
| | affiliated with. |
| ElectronicAddress | Describes the electronic address information |
| | for this person. |

The use example of the characters is described in Table 3.

TABLE 3

```
    <Person>
        <Name xml:lang=“en”>
            <GivenName>John</GivenName>
        <FamilyName>Smith</FamilyName>
        </Name>
        <Name xml:lang=“fr”>
            <GivenName>Jean</GivenName>
            <FamilyName>Smith</FamilyName>
        </Name>
        <Affiliation>
            <Organization>
                <Name>International  Standards
Organization</Name>
            </Organization>
        </Affiliation>
        <ElectronicAddress>
            <Email>john.smith@iso.ch</Email>
```

In one embodiment, a user (e.g., program producer) inputs program information capable of continuously generating the “Person DS” (as shown in Table I.) to the DS generator 313 of FIG. 3. The DS generator 313 generates the corresponding MDS.

In Table 2, in a “Name” region, the names of the currently appearing characters are inscribed, and in an “Affiliation” region, along with an indication regarding the group to which the currently appearing person belongs. The group may be a sports team, for example, instead of an individual. Hence, it is shown that it is contemplated to record the broadcast program only when the members of the sports team appear. The DS analyzer 324 analyzes the additional information included in the transport stream and outputs program-related information. The DS generator 313 and the DS analyzer 324 may be considered as an MPEG-7 encoder and an MPEG-7 decoder, respectively.

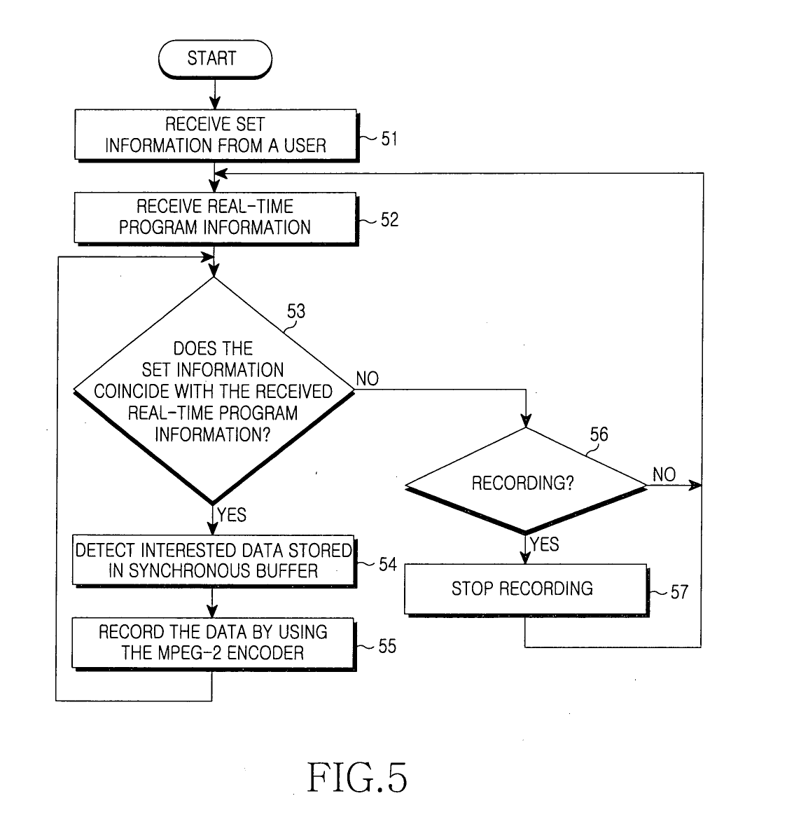

FIG. 5 is a flowchart explaining the operation of the control unit in the recordable PVR according to an embodiment of the present invention.

Referring to FIG. 5, the control unit receives recording preference information from a user to perform a reserved recording (step 51). The recording preference information is input from the user via user input unit 43. The recording preference information input from the user may include recording preference information corresponding to, for example, characters in the digital broadcast or captions included in the broadcast and the like. In the illustrative example above, the recording preference information pertains to characters of the digital broadcast.

The control unit receives the real-time program-related information (step 52). It is noted that in the case of a conventional digital broadcast, because the recording is performed using only the EPG information transmitted at regular intervals or information denoting the start and end points of a broadcast, it is not required to continuously transmit such information. By contrast, in the present invention, since the decision to record particular characters varies from scene to scene in the broadcast, and is determined in real time, the program-related information of the broadcast program must be transmitted, received and analyzed continuously.

The control unit determines whether the recording preference information provided the user matches the received real-time program information (step 53). Since the received real-time program information includes a lot of information, the control unit filters and compares the real-time program-related information with the recording preference information provided by the user. Specifically, the control unit uses only the field of the information set by the user in the program information including various information.

If the recording preference information of the user coincides with the received real-time program information in step 53, the control unit starts to record the program at the corresponding broadcasting time. For this, the control unit detects the data from the data temporarily stored in the synchronous buffer at the interested time (54), and records the data by using the MPEG-2 encoder 44 (55).

If the recording preference information of the user does not match the received real-time program information in step 53, the control unit confirms whether the recording is being performed (step 56). If the recording is not being performed, the control unit proceeds to step 52. If the recording is being performed, the control unit stops the recording (step 57), and proceeds to step 52.

As described above, the present invention has an advantage in that in the case where the user inputs metadata related to the broadcast program, the control unit at the receiver analyzes the metadata in real time, and selectively stores only user preferred segments of the broadcast in real time.

The method of the present invention as described above can be implemented by a program which can be stored in a computer readable recording medium (e.g. CD-ROM, floppy disk, hard disk, optomagnetic disk, and others).

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A personal video recorder (PVR) for recording a digital broadcast, comprising:
a broadcast receiver for receiving the digital broadcast and separating a digital broadcast program into video data, audio data and metadata;
a description schemes (DS) analyzer for analyzing the metadata and outputting program-related information of a digital broadcast program;
a user input unit for receiving recording preference information;
a program information processor for receiving and filtering the program-related information of the digital broadcast program output from the DS analyzer using the recording preference information;
a synchronous buffer for temporarily storing the video data and the audio data while processing the program-related information of the digital broadcast program to facilitate storage of the video data and the audio data in real time;
a recording unit for receiving and encoding the video data and the audio data temporarily stored in the synchronous buffer; and
a control unit for comparing the program-related information filtered by the program information processor with the recording preference information input by the user input unit and controlling the synchronous buffer and the recording unit to store the video data and the audio data in accordance with said comparison.

2. The PVR as claimed in claim 1, wherein the metadata is MPEG-7 encoded data.

3. The PVR as claimed in claim 1, wherein the metadata is MPEG-21 encoded data.

4. The PVR as claimed in claim 1, wherein the synchronous buffer transmits time-stamp information to the control unit corresponding to the stored broadcast data.

5. The PVR as claimed in claim 1, wherein the recording unit comprises:
an MPEG-2 encoder for receiving and encoding the video data and the audio data temporarily stored in the synchronous buffer under the control of the control unit; and
a storage unit for storing the data encoded by the MPEG-2 encoder.

6. The PVR as claimed in claim 1, wherein the recording preference information is information corresponding to characters appearing in a scene.

7. The PVR as claimed in claim 1, wherein the recording preference information refers to an affiliation of characters and scenes in which they appear.

8. The PVR as claimed in claim 4, wherein the control unit compares the program-related information filtered by the program information processor with the recording preference information input by the user input unit to determine if there is a match, and in the case of a match, the control unit commands the recording unit to initiate storage of the video data and the audio data stored in the synchronous buffer at a time point when said match occurs, and in the case when a match no longer occurs, the control unit commands the recording unit to stop recording.

9. A method of controlling a PVR for recording a digital broadcast, the method comprising:
receiving an input of recording preference information from a user;
receiving real-time program-related information extracted from the digital broadcast;
continuously determining whether the recording preference information matches the real-time program information;
initiating a recording of the digital broadcast at a point in time corresponding to when said determination step is satisfied; and
stopping the recording of the digital broadcast at a point in time corresponding to when said determination step is no longer satisfied.
